(19) United States
(12) Patent Application Publication
(10) Pub. No.: US 2019/0313511 A1
(43) Pub. Date: Oct. 10, 2019

(54) Lighting Device That Boosts Light Output When Motion Is Detected

(71) Applicant: Jasco Products Company LLC, Oklahoma City, OK (US)

(72) Inventors: Jason Trice, Oklahom City, OK (US); Rob Workman, Oklahoma City, OK (US); Yolanda Coronel, Oklahoma City, OK (US)

(21) Appl. No.: 16/378,443

(22) Filed: Apr. 8, 2019

Related U.S. Application Data
(60) Provisional application No. 62/654,567, filed on Apr. 9, 2018.

(51) Int. Cl. H05B 37/02; H05B 33/08

(52) U.S. Cl. CPC H05B 37/0227; H05B 33/0872; H05B 33/0854; H05B 37/0218

(57) ABSTRACT

A lighting device having an illumination control means that increases light output from a low light output to a high light output based on motion in an area. The lighting device comprises a power source, a motion sensor for detecting motion in an area, an illumination means, an illumination control means that increases a light output from a low light output to a high light output when motion is detected in an area, a delay timer to revert the lighting device to the low light output when the motion sensor fails to detect motion after a predetermined period of time, a controller, and an electrical circuit. The lighting device may further comprise a light sensor, a multi-mode switch, light output level control, and color temperature control means.

### RELATED APPLICATIONS

This application claims priority from commonly assigned U.S. Provisional Patent Application Ser. No. 62/654,567, filed Apr. 9, 2018, entitled LED NIGHT LIGHT THAT BOOSTS LIGHT OUTPUT WHEN MOTION IS DETECTED, the entire disclosure of which is hereby incorporated by reference.

### BACKGROUND OF THE INVENTION

### 1. Field of the Invention

The present invention pertains to a device for providing motion-actuated light. More specifically, the invention pertains to a lighting device having an illumination control means that increases light output from a low light output to a high light output based on motion in an area.

### 2. Description of Related Art

Lighting devices may be broken down into numerous subsets, one example being: night lights. Traditional night lights are often small, low powered lights placed in darkened areas for comfort, safety, and convenience.

Consumers often desire a night light with a low light output, such that sleep is not discouraged, disturbed, nor affected when the night light is used in a bedroom area. High light output may decrease sleep quality, shorten sleep duration, and lead to further problems. Additionally, consumers often prefer low light output when an area is not occupied or when high light output is not needed.

Conversely, consumers often desire a night light to have a high light output, such that the general layout of the room is illuminated well enough to distinguish furniture, pets, walls, doorways, and other obstacles in an area, so a user may move around safely within a room.

Traditional features have been incorporated into a night light to adapt to individual functional needs. For example, motion sensors allow a night light to turn from off to on when movement is detected in an area. Often, the night light illuminates at a high light output level to illuminate the general layout of a room.

Dimmers have also been added to allow the consumer to select the light output level produced by a night light. The user may select a low light output level conducive to a good nights sleep, or a high light output level to illuminate an area well enough to safely move around.

### SUMMARY OF THE INVENTION

Embodiments of the present invention are directed to a lighting device having an illumination control means that may increase light output from a low light output to a high light output when motion is detected.

One embodiment of the present invention is a lighting device comprising a power source, a motion sensor for detecting motion in an area, an illumination means, an illumination control means that increases the light output from a low light output to a high light output when motion is detected in an area, a delay timer to revert the lighting device to the low light output when the motion sensor fails to detect motion after a predetermined period of time, a controller, and an electrical circuit.

The power source is selected from a group comprising of an AC power source, a DC power source, at least one battery, and a solar power source. The illumination means may be one or more light emitting diodes (LEDs), organic light emitting diodes (OLEDs), halogens, and incandescent lights.

In another embodiment, the lighting device may further comprise a light sensor for detecting ambient light. The light sensor may provide the lighting device the ability to turn on/off when ambient light is at a predetermined level.

The lighting device may further comprise one or more of the following elements: a male electrical plug extending outwardly from the said lighting device; a color temperature control means; and a slide that selects light output level.

In another embodiment of the present invention, a lighting device comprises a power source, a motion sensor for detecting motion in an area, an illumination means, an illumination control means that increases the light output from a low light output to a high light output when motion is detected in an area, a delay timer to revert the lighting device to the low light output when the motion sensor fails to detect motion after a predetermined period of time, a controller, an electrical circuit, and a multi-mode switch feature that allows the user to select different modes of operation. The embodiment may further comprise a light sensor for detecting ambient light.

The multi-mode switch may allow the user to select one of at least two different modes, wherein said modes may be any one of the following: motion boost, motion on/off, motion on/off low light output, motion on/off high light output, motion on/off user select light output, dusk-to-dawn, light sensor disabled, and an always on mode.

Various versions of the embodiments include a lighting device selected from a group comprising of: a plug-in nightlight, a battery operated night light, a table top light with an electrical cord, a battery operated table top light, a linear fixture under cabinet light or lights, an under cabinet puck light, a puck light, a string light, a café light, a landscape light, a lantern, and a lamp.

### BRIEF DESCRIPTION OF THE DRAWINGS

One or more embodiments are illustrated by way of example, and not by limitation, reference will now be made to the accompanying drawings, having the same numeral designations to represent like elements throughout and wherein:

FIG. 1 is an auto motion boost component diagram for one embodiment of the lighting device;

FIG. 2 is a front view of an embodiment of the lighting device;

FIG. 3 is a back view of an embodiment of the lighting device;

FIG. 4 is a left side view of an embodiment of the lighting device;

FIG. 5 is right side view of an embodiment of the lighting device;

FIG. 6 is a front view of another embodiment of the lighting device;

FIG. 7 is a top view of the embodiment of the lighting device in FIG. 6;

FIG. 8 is a bottom view of the embodiment of the lighting device in FIG. 6;

FIG. 9 is a bottom view of an embodiment of the lighting device;

FIG. 10 is a user selectable auto motion boost component diagram for an embodiment of the lighting device;

FIG. 11 is a back view of the embodiment of the lighting device in FIG. 10.

### DETAIL DESCRIPTION OF THE INVENTION

In reference to this patent application, the following terms are defined as follows:
motion boost: light output increase from a low light output to a high light output when motion is detected in an area;
motion on/off: light output increase from a zero light output to a light output when motion is detected in an area;
motion on/off low light output: light output increase from a zero light output to a low light output when motion is detected in an area;
motion on/off high light output: light output increase from a zero light output to a high light output when motion is detected in an area;
motion on/off select light output: light output increase from a zero light output to a user selected light output or a manufacturer selected light output when motion is detected in an area;
dusk-to-dawn: light output when ambient light is below a predetermined level;
light sensor disabled: light output regardless of ambient light;
always on: constant light output when light is connected to a power source.

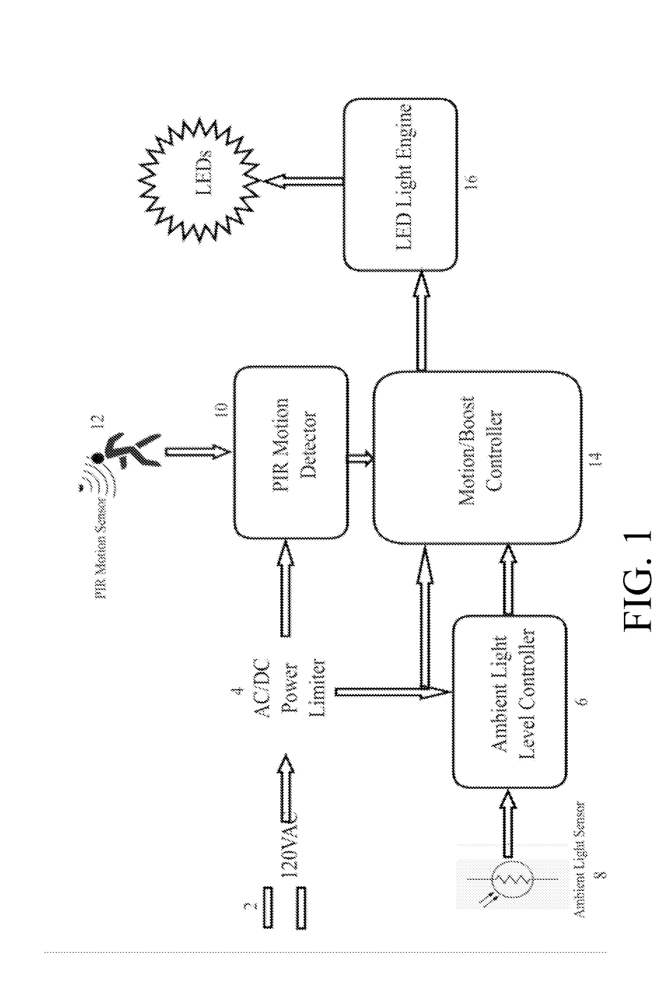

FIG. 1 is an auto motion boost component diagram for one embodiment of the lighting device 100 according to the present invention. The AC/DC power limiter 4 receives power from an AC power source 2. The AC/DC power limiter 4 directs power to an ambient light level controller 6. An ambient light sensor 8 detects ambient light level and is electrically connected to the ambient light level controller 6. The ambient light level controller 6 is electrically connected to the motion boost controller 14, which commands the device to turn on when the ambient light is below a predetermined level. The predetermined ambient light level may be adjustable to accommodate an individual user.

The AC/DC power limiter 4 also directs power to a motion detector 10, which is electrically connected to a motion sensor 12. The motion sensor 12 detects motion in an area and communicates with the motion detector 10. The motion sensor 12 may be a PIR motion senor, and the motion detector 10 may be a PIR motion detector.

In FIG. 1, a motion boost controller 14 receives power from the AC/DC power limiter 4. The motion boost controller 14 receives input from the ambient light level controller 6 and the motion detector 10. When the ambient light sensor 8 detects light below a predetermined level, the lighting device illuminates at a low light output. A measured unit, an example being but not limited to 3 lumens, may define the low light output. A dimmed max light output, an example being but not limited to 50% of max light output, alternatively may define the low light output. The low light output level may be adjustably controlled by the user, and/or set by the manufacturer.

When the ambient light sensor 8 detects light below a predetermined level, and the motion sensor 12 detects motion in an area, the lighting device illuminates at a high light output. A measured unit, an example being but not limited to 400 lumens, may define the max light output. A dimmed max light output, an example being but not limited to 100% of max light output, alternatively may define the high light output.

The motion boost controller 14 commands the light output level to the LED light engine 16. The LED light engine 16 may illuminate at a low light output, a high light output, or an individualized light output set from zero to max light output.

The lighting device 100 further comprises a delay timer to revert the lighting device to the low light output when the motion sensor 12 fails to detect motion after a predetermined period of time. The predetermined period of time may be adjustably controlled by the user, and/or set by the manufacturer.

In an alternate embodiment, the lighting device 100 having an illumination control means that increases light output from a low light output to a high light output based on motion in an area may be comprised of a power source 2, a motion sensor 12, an illumination means, a delay timer, a controller, and an electrical circuit. In this particular embodiment, without a light sensor 8 or an ambient light level controller 6, the lighting device 100 illuminates regardless of the ambient light level.

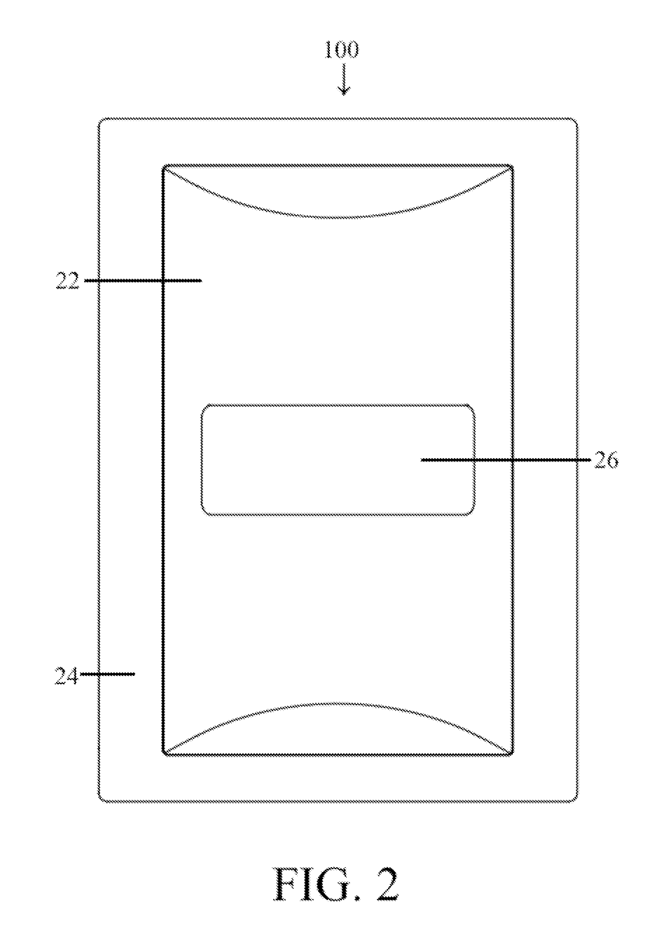

FIG. 2 is a front view of an embodiment of the lighting device 100. The lighting device 100 may comprise a front cover 22. The front cover 22 may be manufactured from various materials or compositions, including but not limited to brushed nickel or plastic. A transparent lens 24 is visible below, above, and on both sides of the front cover 22. A lens 26 is enclosed by the front cover 22 of the lighting device. The lighting device 100 illumination means may be one or more light emitting diodes (LEDs), organic light emitting diodes (OLEDs), halogens, and incandescent lights.

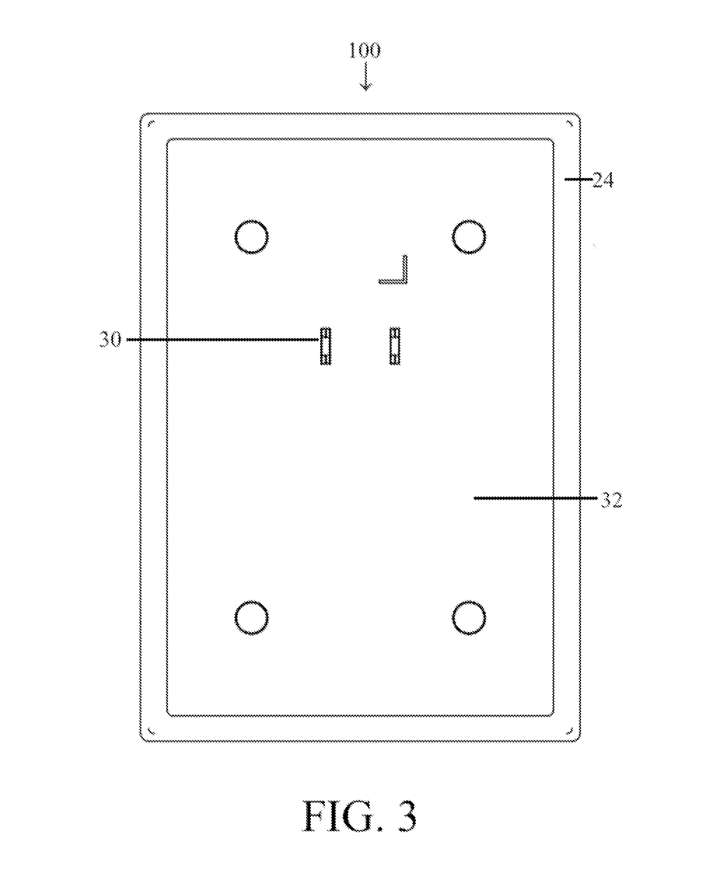

FIG. 3 is a back view of an embodiment of the lighting device 100. A male electrical plug 30 extends outwardly through a back cover 32 of the lighting device 100. The male electrical plug 30 may be inserted into the receptacle of the AC power source 2 (not pictured) to provide a physical and electrical connection. The back cover 32 may be enclosed by or sit within the transparent lens 24.

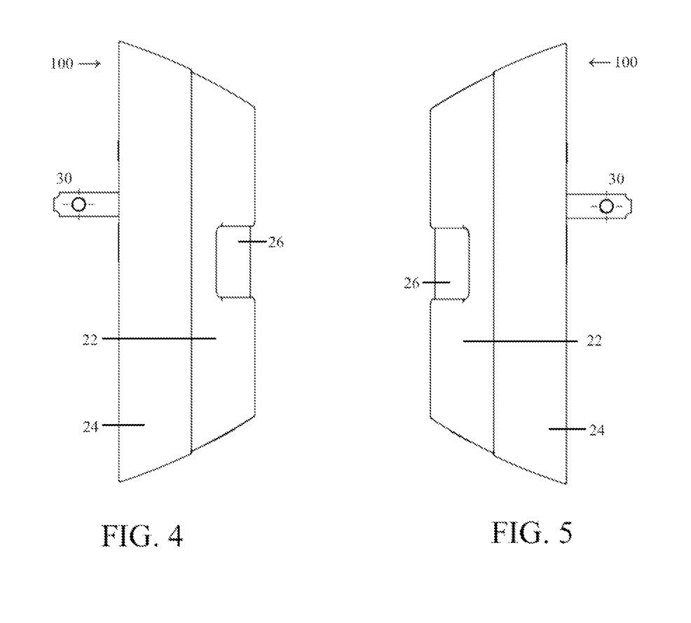

FIG. 4 and FIG. 5 are side views of an embodiment of the lighting device 100. The male electrical plug 30 may be placed in various locations on the lighting device 100. In this embodiment of the present invention, the electrical plug extends through the back cover 32 (not pictured) in a location that allows the lighting device 100 to cover a standard AC receptacle wall plate (not pictured), which provides an aesthetic advantage for users while functionally placing a barrier to unwanted further access to the AC receptacle. The relative size of the transparent lens 24, front cover 22, and lens 26 of this particular embodiment are illustrated within FIG. 4 and FIG. 5. The relative size and locations of the individual elements may be changed and still be within the scope of the invention.

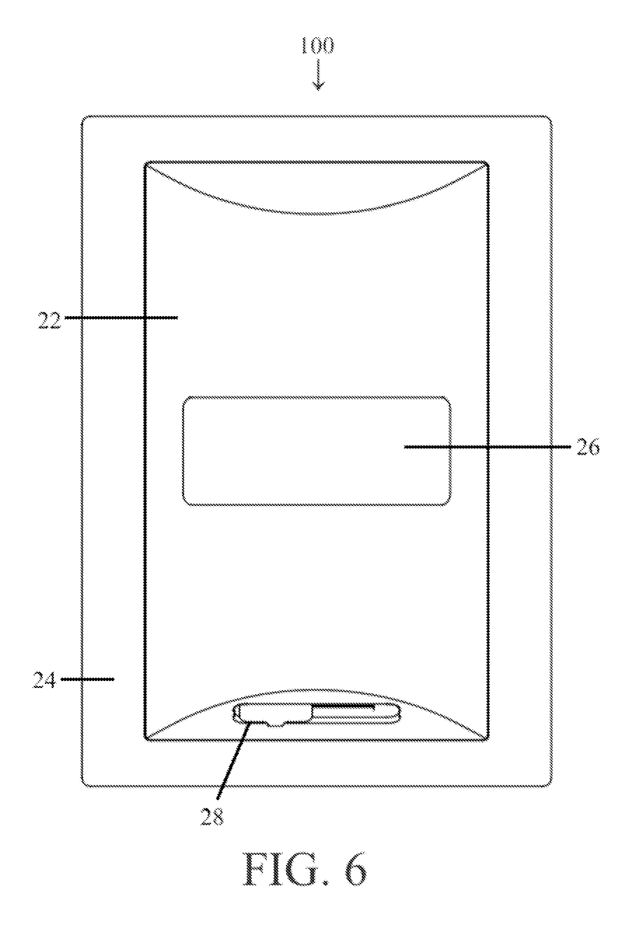

Referring to another embodiment of the lighting device 100 in FIG. 6, the lighting device 100 furthers comprises a slide 28. The slide 28 provides a user the ability to have personalized control of the light output level. In various embodiments, the user may control the light output level of one or more of the following: low light output, high light output, motion on/off light output, dusk-to-dawn light output, light sensor disabled light output, and always on light output. The user may select a light output level from zero percent to one hundred percent illumination.

A lever, knob, switch, or other may be used in replacement for the slide 28. In the embodiment illustrated in FIG. 6, the slide 28 is located below the lens 26 and is mounted on the lower portion of the front cover 22. The location of the lever, knob switch, slide 28, or other may be changed and still fall within the scope of this invention. The transparent lens 24 is visible below, above, and on both sides of the front cover 22.

In another embodiment of the lighting device 100, the temperature may be selected with a temperature control means comprising one or more of the following: a lever, a knob, a switch, or a slide. The temperature may be selected within in a range, example being from 1600K to 7000K. The temperature control means provides the user with various lighting colors, including but not limited to: warm white light, cool white light, day light candle light, and sleep light.

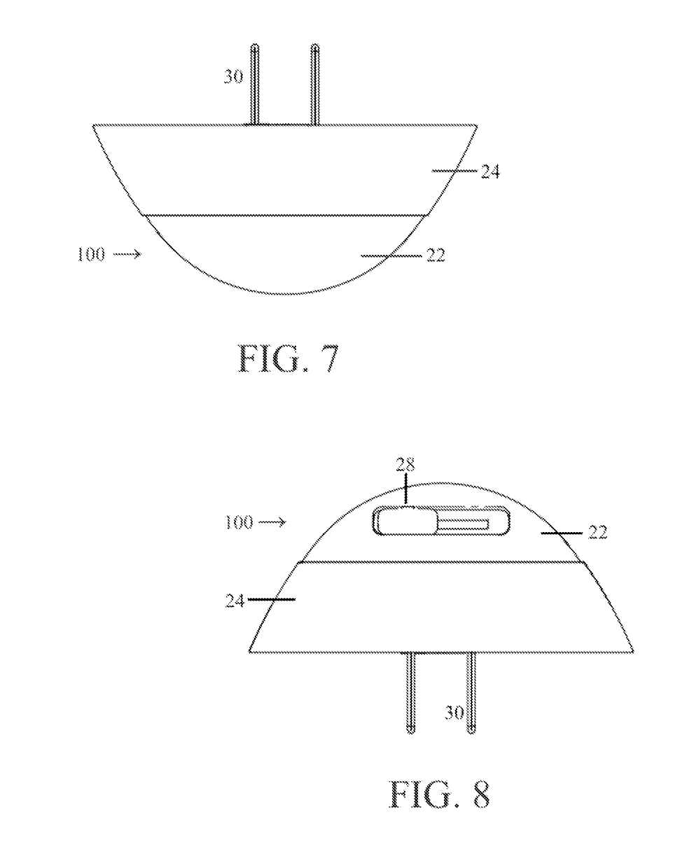

FIG. 7 and FIG. 8 are top and bottom views of an embodiment of the lighting device 100.

FIG. 8 illustrates the slide 28, which provides the user the ability to have personalized control of the light output level. The front cover 22, the transparent lens 24, and the male electrical plug 30 are each illustrated in FIG. 7 and FIG. 8.

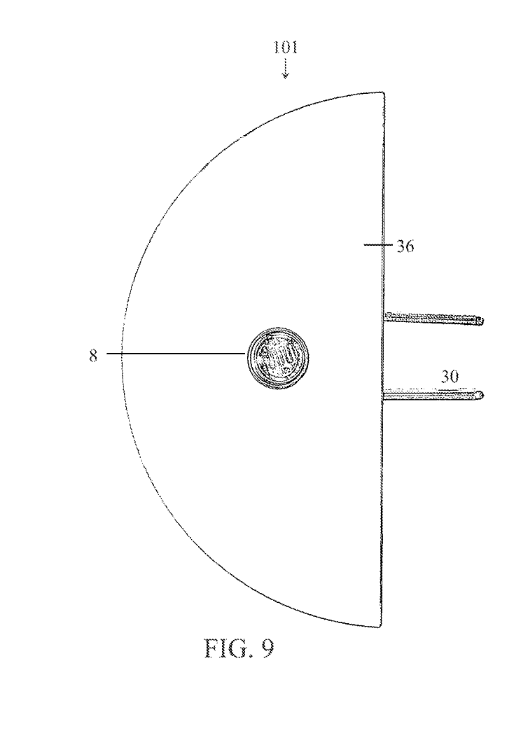

FIG. 9 is a bottom view of an embodiment of a lighting device 101. An ambient light sensor 8 extends through a housing 36. The ambient light sensor 8 detects the ambient light level and communicates with the ambient light level controller 6 (not pictured). The lighting device 101 turns on when the ambient light is below a predetermined level. The male electrical plug 30 extends through the housing 36 to connect to an AC power source 2 (not pictured).

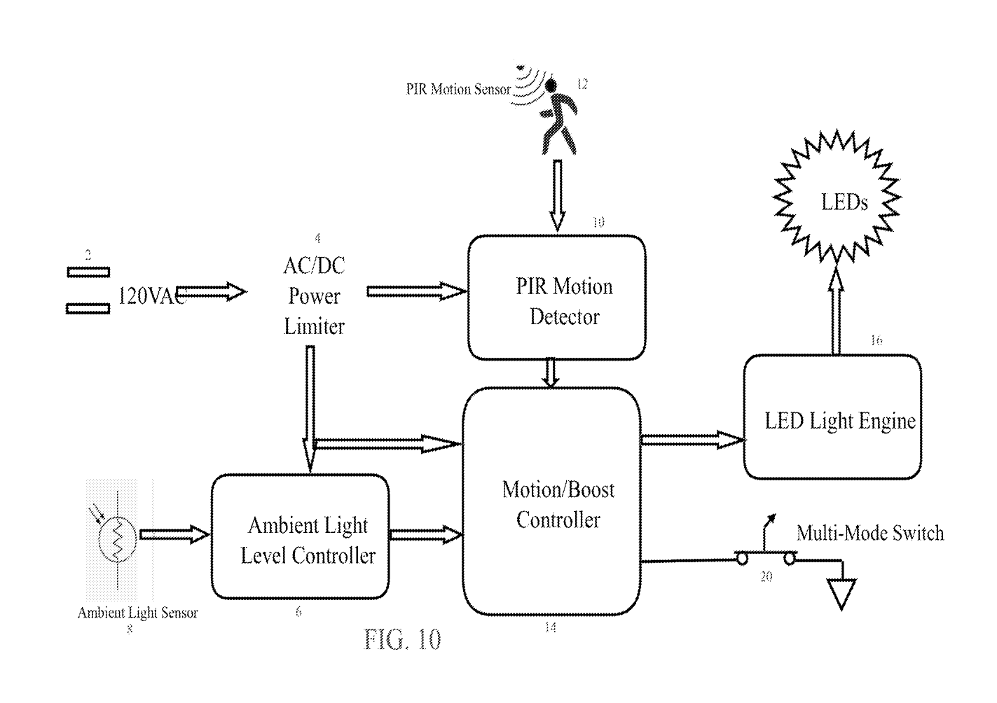

In FIG. 10, a multi-mode switch 20 is electrically connected to the motion boost controller 14 which allows the user to select different modes, such as: motion boost, motion on/off, motion on/off low light output, motion on/off high light output, motion on/off user select light output, dusk-to-dawn, light sensor disabled, and always on mode.

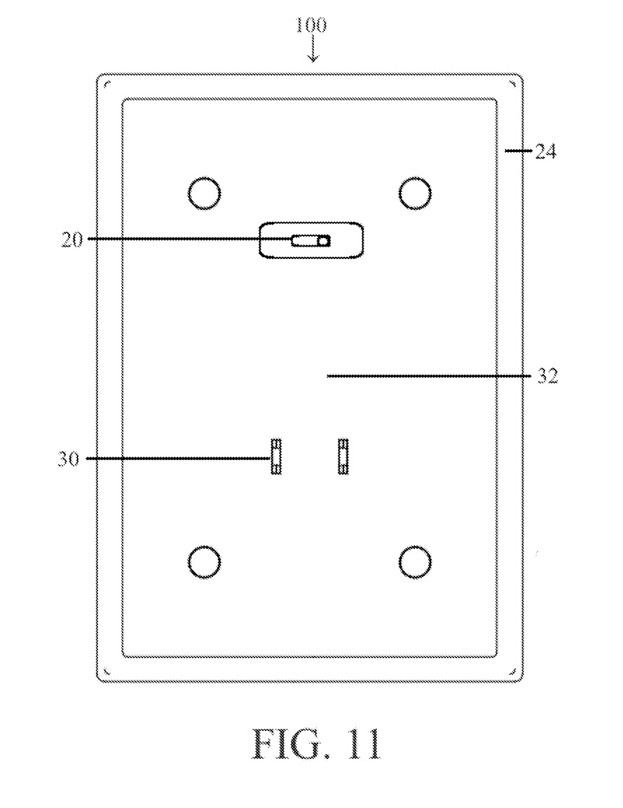

FIG. 11 is a back view of another embodiment of the lighting device 100. The multi-mode switch 20 is mounted on the back cover 32 of the lighting device 100. Various embodiments of the present invention exist.

In one embodiment, the multi-mode switch 20 may comprise a two-way switch that allows the user to select between one of two modes. The modes which may be selected from, in various embodiments of the present invention, include but are not limited to: motion boost, motion on/off, motion on/off low light output, motion on/off high light output, motion on/off user select light output, dusk-to-dawn, light sensor disabled, and an always on mode.

In another embodiment, the multi-mode switch 20 may comprise a three-way switch that allows the user to select between one of three modes. The modes which may be selected from, in various embodiments of the present invention, include but are not limited to: motion boost, motion on/off, motion on/off low light output, motion on/off high light output, motion on/off user select light output, dusk-to-dawn, light sensor disabled, and an always on mode.

In FIG. 11, the male electrical plug 30 extends through the back cover 32. The back cover 32 may be enclosed by or sit within the transparent lens 24.

The lighting device of the previous embodiments within the entirety of this invention may be anyone of the following, but not limited to: a plug-in light, a battery operated night light, a wall mount light, a table top light with an electrical cord, a battery operated table top light, a linear fixture under cabinet light or lights, an under cabinet puck light, a puck light, a string light or lights, a café light or lights, a landscape light, a lantern, and a lamp.

Although the present invention has been described in relation to particular embodiments thereof, many other variations and modifications will become apparent to those skilled in the art. It is preferred, therefore, that the present invention be limited not by the specific disclosure herein, but only by the appended claims. Alternate embodiments may be devised without departing from the spirit or scope of the invention. Further, the particular feature or structure may be combined in any suitable manner in one or more embodiments.

What is claimed is:

1. A lighting device comprising:
a power source;
a motion sensor for detecting motion in an area;
an illumination means;
an illumination control means which increases a light output from a low light output to a high light output when motion is detected in an area;
a delay timer to revert the lighting device to the low light output when the motion sensor fails to detect motion after a predetermined period of time;
a controller; and
an electrical circuit.

2. The lighting device of claim 1, wherein the power source is selected from a group comprising of an AC power source, a DC power source, at least one battery, and a solar power source.

3. The lighting device of claim 1, further comprising a light sensor for detecting ambient light level.

4. The lighting device of claim 1, further comprising a male electrical plug extending outwardly from said lighting device.

5. The lighting device of claim 1, wherein the lighting device is selected from a group comprising of: a plug-in night light, a battery operated night light, a table top light with an electrical cord, a battery operated table top light, a linear fixture under cabinet light or lights, an under cabinet puck light, a puck light, a string light or lights, a café light or lights, a landscape light, a lantern, and a lamp.

6. The lighting device of claim 1, wherein the illumination means is selected from a group comprising of: one or more light emitting diodes (LEDs), organic light emitting diodes (OLEDs), halogens, and incandescent lights.

7. The lighting device of claim 1, further comprising color temperature control means, wherein said color temperature control may be selected by a user in a range from 1600K to 7000K.

8. The lighting device of claim 1, further comprising a slide that selects light output level, wherein said light output level may be selected by a user in a range from zero percent to one hundred percent illumination.

9. A lighting device comprising:
a power source;
a motion sensor for detecting motion in an area;
an illumination means;
an illumination control means that increases a light output from a low light output to a high light output when motion is detected in an area;
a delay timer to revert the lighting device to the low light output when the motion sensor fails to detect motion after a predetermined period of time;
a controller;
an electrical circuit; and
a multi-mode switch that allows a user to select different modes of operation.

10. The lighting device of claim 9, wherein the power source is selected from a group comprising of an AC power source, a DC power source, at least one battery, and a solar power source.

11. The lighting device of claim 9, further comprising a male electrical plug extending outwardly from said lighting device.

12. The lighting device of claim 9, wherein the lighting device is selected from a group comprising of: a plug-in night light, a battery operated night light, a table top light with an electrical cord, a battery operated table top light, a linear fixture under cabinet light or lights, an under cabinet puck light, a puck light, a string light or lights, a café light or lights, a landscape light, a lantern, and a lamp.

13. The lighting device of claim 9, wherein the illumination means is selected from a group comprising of: one or more light emitting diodes (LEDs), organic light emitting diodes (OLEDs), halogens, and incandescent lights.

14. The lighting device of claim 9, further comprising color temperature control means, wherein said color temperature control may be selected by a user in a range from 1600K to 7000K.

15. The lighting device of claim 9, further comprising a slide that selects light output level, wherein said light output level may be selected by a user in a range from zero percent to one hundred percent illumination.

16. The lighting device of claim 9, wherein the multi-mode switch allows a user to select one of at least two different modes, wherein said modes may be any one of the following: motion boost, motion on/off, motion on/off low light output, motion on/off high light output, motion on/off user select light output, and an always on mode.

17. The lighting device of claim 9, further comprising a light sensor for detecting ambient light level.

18. A lighting device comprising:
a power source;
a motion sensor for detecting motion in an area;
a light sensor for detecting ambient light level;
an illumination means;
an illumination control means that increases a light output from a low light output to a high light output when motion is detected in an area;
a delay timer to revert the lighting device to the low light output when the motion sensor fails to detect motion after a predetermined period of time;
a controller;
an electrical circuit; and
a multi-mode switch that allows a user to select one of at least two different modes, wherein said modes may be any one of the following: motion boost, motion on/off, motion on/off low light output, motion on/off high light output, motion on/off user select light output, dusk-to-dawn, light sensor disabled, and an always on mode.
